(19) United States
(12) Patent Application Publication
(10) Pub. No.: US 2009/0205845 A1
(43) Pub. Date: Aug. 20, 2009

(54) SYSTEM AND METHOD FOR EXTINGUISHING WILDFIRES

(75) Inventor: John A. Hoffman, San Diego, CA (US)

Correspondence Address: KELLY LOWRY & KELLEY, LLP, 6320 CANOGA AVENUE, SUITE 1650, WOODLAND HILLS, CA, 91367, US

(73) Assignee: Fire Termination Equipment, Incorporated, San Diego, CA (US)

(21) Appl. No.: 12/370,433

(22) Filed: Feb. 12, 2009

Related U.S. Application Data
(60) Provisional application No. 61/065,964, filed on Feb. 16, 2008.

(51) Int. Cl. A62C 3/00; G05D 1/00

(52) U.S. Cl. 169/43; 701/2; 169/70

(57) ABSTRACT

A method for extinguishing fires includes the steps of loading an unmanned aerial vehicle (UAV) onto a transport aircraft and carrying the UAV to an altitude and location in proximity to a fire area. The UAV is launched from the transport aircraft and guided over the fire area using controllable fixed or deployable aerodynamic structures operably connected to the UAV. Once over the appropriate location, the UAV releases fire extinguishing or retardant material onto the fire or anticipated fire path.

### BACKGROUND OF THE INVENTION

The present invention generally relates to fire control. More particularly, the present invention relates to a system and method for extinguishing wildfires.

There are areas in the world, such as the Western United States, Florida, Australia, etc., where wildfires occur on a regular, if not seasonal basis. Typically, these areas will have a wet season, followed by a dry and windy season which dries out plant life and raises the possibility for wildfires. With the ever increasing population, as well as national parks and timber reserves and the like, wildfires can create large financial losses as well as presenting a danger to people visiting or living in such areas.

Fighting forest fires and wildfires has traditionally been done using manned aerial tanker aircraft, either in the form of airplanes or helicopters. Helicopters may be fitted with tanks or carry buckets. The buckets are usually filled by submerging them in lakes, rivers, reservoirs or portable tanks. Tanks may be filled on the ground or water may be siphoned from lakes or reservoirs or the like through a hanging snorkel. Air tankers or water bombers are fixed-wing aircraft fitted with tanks that can be filled on the ground at an air tanker base, or in the case of flying boats and amphibious aircraft by skimming water from lakes, reservoirs or large rivers. In 2003, it was reported that the U.S. Forest Service and Bureau of Land Management own, lease or contract with nearly one thousand aircraft each fire season, with annual expenditures in excess of Two Hundred Fifty Million Dollars.

The fixed or rotary wing aircraft deliver water or fire retardant materials or fluids to the fire sites where they are released manually by aircraft pilots to target the fire locations. The aerial tanker aircraft supplement the efforts by ground crews that control fires by direct application of water or retardant chemicals and by cutting fire breaks. Aircraft are capable of dropping several thousand gallons of water or fire retardant in a single pass, and are also capable of dropping the water or fire retardant on areas which are inaccessible, or difficult to reach, by the ground crews.

However, the present aerial tanker aircraft approach requires flying very close to the ground in order to precisely dispense the fire control fluids (water or fire retardant) onto the fire hot spots. Such aircraft operations are dangerous to aircraft and operating crews, especially in the presence of high winds usually associated with wildfires and the limited visibility caused by smoke and flying debris. Further, such flight operations are extremely dangerous to impossible after dark as pilots are unable to detect obstructions near the ground due to the limited visibility. According to the U.S. Forest Service, between 1996 and 2006, there were twenty aerial firefighting accidents and thirteen fatalities.

Therefore, aerial tanker firefighting has been limited in effectiveness by the risk to the aircraft, the risk to the flight personnel, the inability to operate effectively in high winds, the limited ability to target precisely due to smoke and debris, and the inability to operate after dark. Notwithstanding these limitations, aerial firefighting continues to be used in conjunction with ground-based efforts due to their importance. In fact, there have been cases of aircraft extinguishing fires long before ground crews even arrived.

Accordingly, there is a continuing need for a new system and method for fighting wildfires which incorporates the advantages of using aircraft, while overcoming the current obstacles and limitations of manned aerial tanker aircraft approaches. The present invention fulfills these needs, and provides other related advantages.

### SUMMARY OF THE INVENTION

The present invention resides in a system and method for extinguishing fires, and is particularly adapted for extinguishing wildfires and forest fires and the like. The present invention incorporates the use of unmanned aerial vehicles in extinguishing such fires.

More particularly, the method of the present invention includes the steps of loading an unmanned aerial vehicle (UAV) onto a transport aircraft. This may be done by attaching the UAV to the exterior of the transport aircraft, or placing the UAV into the transport aircraft. The UAV is carried to an altitude and location in relation to a fire area. The fire area comprises a fire or an anticipated fire path. The UAV is then launched from the transport aircraft.

The UAV is guided over the fire area using controllable fixed or deployable aerodynamic structures of the UAV. Such fixed or deployable aerodynamic structures comprise at least one of a propellor, a jet, a paraglider parachute, or controllable wing structures operably connected to the UAV.

In one embodiment, a ground-based communicator or the transport aircraft is in communication with and controls the flight of the UAV. This may be done by means of wireless electromagnetic waves or an optical sensor or a camera which assist in remotely guiding and controlling the flight of the UAV. The guiding step may also include the step of using navigation position data to guide and control the flight of the aircraft. Such navigation position data include global position satellite (GPS) data, radio beacon data, very high frequency omni-directional range (VOR) data, and long range aid to navigation (LORAN) data. Data is imported into a data processor, such as the transport vehicle or ground-based control system, for controlling the UAV. It will also be appreciated that such data can be input into the UAV prior to launch, such that the UAV is self-guided.

Preferably, conditions relating to the fire are determined and tracked. Such conditions include weather conditions such as wind speed, direction, humidity and the like. Flight conditions of the UAV are also monitored, which include altitude and location and speed of the UAV.

When the UAV is guided over the appropriate location, fire extinguishing or retardant material is released from the UAV and onto the fire area. Although the UAV may be a single use application, such that it is destroyed during the release step, in a particularly preferred embodiment, the UAV is recoverable for future use.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of a transport aircraft having taken off from an airport and proceeding to a fire area, and carrying an unmanned aerial vehicle (UAV), and in communication with ground-based navigation positioning data systems, in accordance with the present invention;

FIG. 2 is another diagrammatic view illustrating the launching of the UAV from the transport airplane, and the guiding of the UAV over a fire and the release of fire extinguishing or retardant material onto the fire, in accordance with the present invention;

FIG. 3 is a diagrammatic view of an UAV embodying the present invention and releasing fire extinguishing or retardant material from a storage compartment thereof;

FIG. 4 is a perspective diagrammatic view of a transport plane and another UAV embodying the present invention, in wireless communication with one another, in accordance with the present invention;

FIG. 5 is a diagrammatic perspective view of yet another UAV embodying the present invention and in wireless communication with a ground-based control system, in accordance with the present invention;

FIG. 6 is a perspective view of yet another UAV embodying the present invention, and incorporating a paraglider parachute for controlling the flight thereof; and

FIG. 7 is a block diagram illustrating the importing of various data into a data processor and used to control the UAV in accordance with the present invention.

### DETAILED DESCRIPTION OF THE PREFERRED EMBODIMENTS

As illustrated in the accompanying drawings, for purposes of illustration, the present invention is directed to a system and method for extinguishing fires. As will be more fully described herein, the invention utilizes unmanned aerial vehicles (UAVs) that are precision navigated and controlled to fire locations using position, altitude, and rate sensing navigation position data and control systems of the UAV. Once over the pre-designated portion of the fire, or an anticipated fire path, the UAV releases fire extinguishing or fire retardant material. The UAVs are carried to the proximity of the fire area by a large manned transport aircraft, and released at a safe altitude from which they home in on designated and/or sensed fire locations.

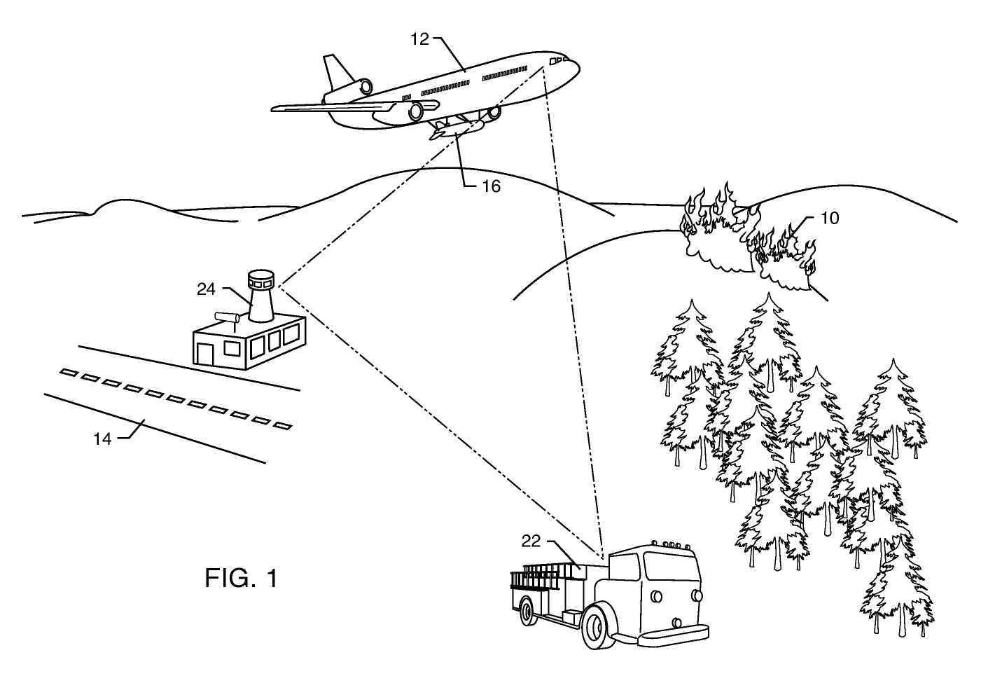

With reference now to FIG. 1, a diagrammatic overview of the invention is illustrated. As mentioned above, the present invention is directed to a system and method for extinguishing fires. The system is particularly adapted for use in extinguishing forest fires or wildfires 10, such as that illustrated in FIG. 1. Such wildfires destroy tens of thousands of acres of grass, shrubs, trees, as well as residential and commercial structures and occasionally account for loss of life as well.

In accordance with the present invention, a large manned transport aircraft, sometimes referred to herein as a fire plane, takes off from an airport 14 a distance from the fire area 10. The term “fire area” as used herein includes not only the actual fire, but also the anticipated path of the fire such that water or fire retardant materials can be dropped thereon to prevent the progress of the fire. The airport 14 may be many miles from the fire area 10. However, the large manned transport aircraft 12, such as a C-130 cargo plane, or other cargo or commercial jet airplane, can fly quite rapidly to arrive in proximity to the fire area 10 in a matter of minutes or hours. In fact, utilizing such large manned transport aircraft 12 enable bases supporting the present invention to support a much larger geographic area than systems currently in place which utilize rotary aircraft in the form of helicopters, or propellor-driven air tankers or water bombers and the like. Moreover, such commercial or cargo large manned transport aircraft 12 typically have a much longer range than helicopters or propellor-driven water bombers or the like.

The large manned transport aircraft 12 include all the instruments permitting flight under the U.S. Federal Aviation Administration's (FAA's) Instrument Flight Rules (IFR) for all segments of every flight, including takeoff, enroute and landing, etc. These instruments permit flight of the airplane 12 in any conditions authorized by FAA IFR, including adverse weather conditions, night flying and the like.

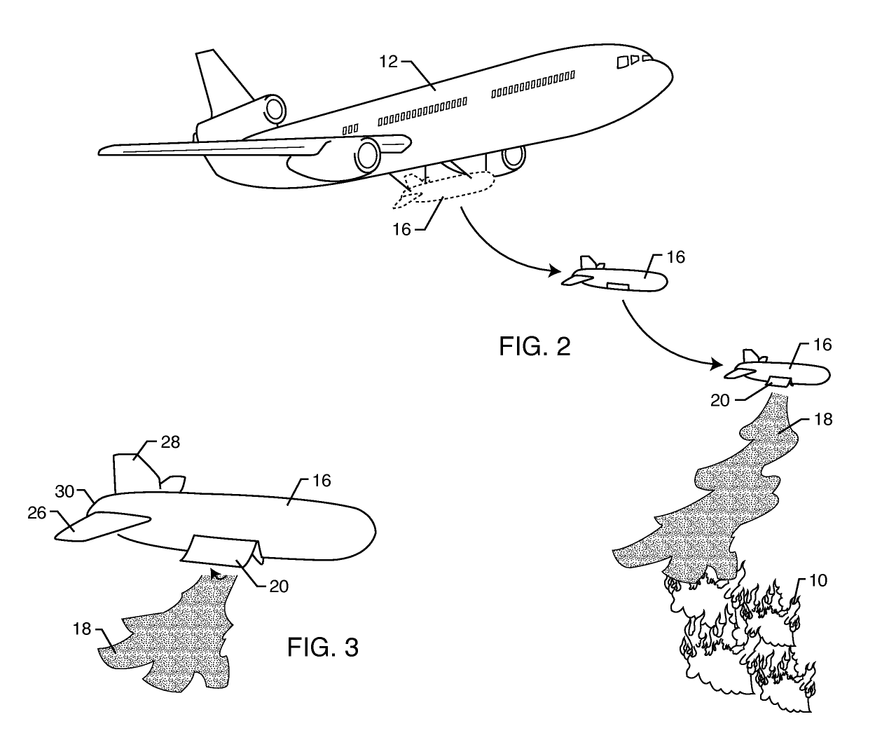

The transport aircraft 12 are of a size and configuration so as to hold or have attached thereto one or more unmanned aerial vehicles (UAV) 16. Each fire plane or transport aircraft 12 will carry one or more UAVs 16 from an operational base, including an airport runway 14 from which the transport aircraft 12 takes off to a site in the vicinity of the wildfires 10. In the accompanying drawings, such as that illustrated in FIGS. 1 and 2, a single UAV is illustrated attached to the transport aircraft 12 on an underbelly thereof. However, it will be understood by those skilled in the art that one or more UAVs may be externally mounted to the transport aircraft 12, such as the underbelly, side of the transport aircraft 12, or the like. The present invention also contemplates that one or more UAVs can be placed within the transport aircraft 12, and either released from a rear exit, such as a B-727 having a rear opening door, or ejected from a side interface wherein the transport aircraft 12 includes side-access doors fitted with a mechanism including rails or the like to move in position the UAV from inside of the transport aircraft 12 to outside of the transport aircraft for launch or jettison. The important aspect of the present invention is that one or more UAVs 16 are transported and carried by the transport aircraft 12 to an altitude and location in relation to a fire area 10.

In the instance illustrated wherein the UAV 16 is releasably attached to the exterior of the transport aircraft 12, as illustrated in FIGS. 1 and 2, the UAV 16 is released or otherwise launched from the transport aircraft 12 for safe clearance from the exterior of the fire plane 12. As will be more fully explained herein, the UAV 16 is configured to releasably hold fire extinguishing or retardant material 18, such as in a storage compartment thereof. The UAV is guided and controlled to a desired position over the fire area 10, such as directly over a fire or an anticipated fire path of the fire 10, and selectively and controllably releases the fire extinguishing or retardant material 18.

As illustrated in FIGS. 2 and 3, the UAV includes doors 20 which can be selectively opened to release the fire extinguishing or retardant material within a storage container of the UAV. However, any suitable means for ejecting and releasing fire retardant material or fire extinguishing material, such as water, from the UAV is contemplated by the invention. Such may include releasable pods, spray systems, or the UAV may be comprised of a frangible, preferably biodegradable, material which is designed to come apart or crash into the fire area 10. Such a UAV would be non-recoverable, although in the preferred embodiments of the invention the UAV is recoverable, as will be more fully described herein.

Referring again to FIGS. 1 and 2, the transport aircraft 12 is manned and can fly very quickly to a fire area 10 at a safe altitude and using standard instrumentation for navigation and control. It will carry one or more UAVs 16 that can be placed into flight, or launched, from the transport aircraft 12, and thereafter fly and be guided to the fire area 10 to apply the appropriate fluids and materials to suppress and eventually distinguish the fire. Multiple UAVs 16 can be deployed in sequence to apply the required quantity of fluid.

Not only can the UAV be fitted with different means for transporting and releasing the fire extinguishing or retardant fluid or material, but the time or process in which such fire extinguishing or retardant material is loaded onto or into the UAV can vary. For example, the UAV may be filled or fitted with the fire extinguishing or retardant material prior to being attached to or received into the transport aircraft 12. Alternatively, an empty UAV may be loaded onto or into the transport aircraft 12, and a tank of fire extinguishing or retardant material within the transport aircraft 12 is used to fill the storage container(s) of the UAV 16 during flight. It is contemplated by the present invention that the UAV filling could occur either inside or outside of the transport aircraft 12. In one embodiment, the UAVs are transported empty, and during ejection, they are mounted to the end of a hose or similar device and the device is extended out from the transport aircraft 12 similar to an operation now used for aircraft mid-air refueling. The UAV is filled through the hose device after it is outside of the transport aircraft 12 and then remotely disconnected from the hose to begin its flight to the fire area 10. This interface might be used in conjunction with either internal or external carry configurations. It is also contemplated by the present invention that such an arrangement could be used for refilling the UAVs 16, or that a dedicated manned airplane, similar to a fuel tanker, could be used to fill the empty UAVs.

As indicated above, the UAV includes a large fluid storage compartment to contain water or other forms of fire extinguishing or fire retardant material. The UAV 16 illustrated in FIGS. 1-3 includes an internal storage compartment. However, it will be appreciated that such a storage compartment can be releasably attached to the UAV, or may comprise multiple storage compartments.

The UAV also includes computerized means for receiving and processing navigation positioning data. Such navigation positioning data may include global positioning satellite (GPS) data, radio beacon data, very high frequency omni-directional range (VOR) data, and long range aid to navigation (LORAN) data. Such data may be input into the computerized system of the UAV prior to flight, or may be wirelessly transmitted to the UAV using either the transport aircraft 12, or ground-based system such as the illustrated fire truck 22, radio beacon, VOR or LORAN data signal transmitters 24. As such, the UAV includes GPS receivers, VOR receivers, LORAN receivers, or the like. The UAV may also include, either alternatively or in addition to the above, Inertial Navigation Systems (INS) which support navigation which provide suitable motion sensing for UAV control.

The UAV may also include sensors for monitoring and determining conditions, including weather conditions and its flight conditions. Weather conditions can include wind speed, wind direction, humidity, and temperature. Conditions relating to the flight of the UAV can include the monitoring of altitude, speed, location, and attitude of the UAV. The UAV may also include sensors for determining conditions relating to the fire, such as heat sensors, infrared sensors and the like. Other sensors may include angle-of-attack and side slip vanes, barometric pressure measurement systems, pilot-static systems for speed and altitude determination and the like. The sensors or other processors to locate a target may include, but are not limited to infrared detectors, light contrast detectors or pattern recognition from video pictures, laser detectors, optical equipment and cameras, embedded radio transmitters/trackers, and the like. The sensors may participate in navigating and controlling the UAV to track to a fire area, or a preloaded mission plan might be used exclusively. Along those lines, the monitoring and determination of such information may be done outside of the UAV, and the information either used in controlling the flight path or guiding the UAV, or transmitted to the UAV to assist the UAV in successfully flying and delivering its payload. Thus, the sensors and receivers may be disposed within or on the UAV 16, the transport plane 12, or ground-based systems 22 and 24 and the like.

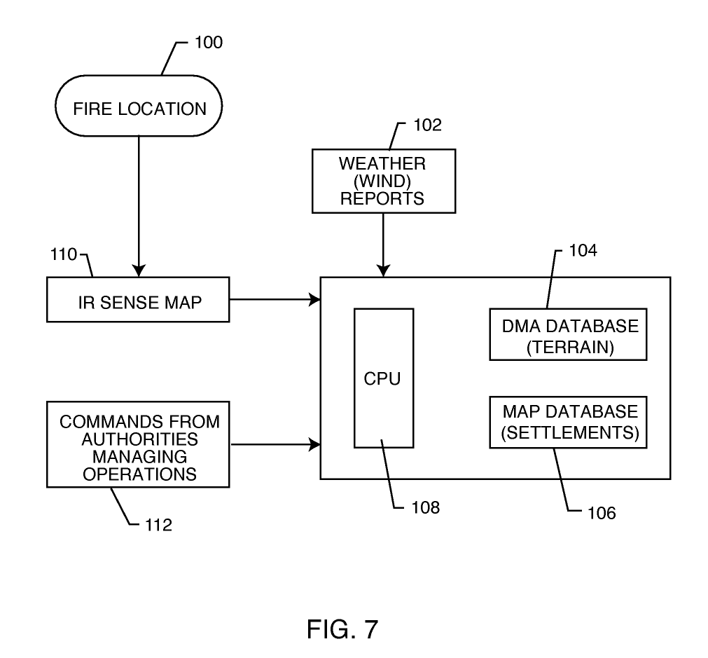

With reference now to FIG. 7, data processors, in the form of computers and the like, process information to define the mission plans that specify what each UAV 16 must do in order to effectively attack the fire and then be recovered, if recovery is applicable. The mission plan data will define the flight trajectory, location for application of fire extinguishing or retardant fluid, location for deploying parachutes, propulsion system control, and any other parameters involved in managing the UAV during its flight. The software and associated computer may be located on the transport aircraft 12, the UAV 16, ground facilities 22 and 24, or may be distributed between one or more of these. It is anticipated that the data processor will receive at least three categories of data input to process. These include first, sensed information relating specifically to the present situation such as fire location 100, weather conditions 102, fuel type of burning, etc. As this information may change over time, this information can be updated as needed. Secondly, pre-defined database information such as terrain feature definitions 104, maps 106 showing locations of structures, roads, etc. and the like are extracted as needed by the data processor, in the form of a computer processor 108. Infrared imaging information and maps may also be acquired, either directly from the UAV, the transport aircraft 12, satellite imagery, or even ground-based systems 110 as needed. Lastly, command information received from authorities directing the campaign against the fire, in the form of commands from authorities managing operations 112 is input into the data processor 108.

The collective data is processed in an algorithm to determine and compute the UAVs 16 mission plan. This also provides information for the system operators. Other information may be provided as required. The collected and processed data may be used by the managing authorities. The data processor 108 can be located within the UAV itself, or on the transport plane 12, or in ground-based facilities or portable systems as needed. In a particularly preferred embodiment, the data processor 108 is either on the transport plane 12 or in ground-based systems, which then control the flight and guide the UAV to its target.

Telemetry, or other wireless means, and other communications equipment are associated with the computers and sensors and effectively communicate information among all airborne and ground-based assets participating in the firefighting operations. Also, communications occur with the authorities managing the fire suppression using various means available to them including two-way radio, internet protocol communications, other wireless exchanges and the like. The computerized system preferably can receive communicated command, control and intelligence information regarding the situation and management of a fire event and adjust the parameters of the UAV flight appropriately in light of such command and control information. For example, the UAV flight control system may either use the information, or be controlled, to adjust its actions to maintain a precise flight path in the presence of wind disturbances, fire flare-ups, or other factors. Thus, all necessary data is imported into the data processor and eventually used to control the UAV.

The UAV 16 includes fixed or deployable aerodynamic structures for guiding and controlling the flight of the UAV, whether it be automatically controlled internally within the UAV itself, or remotely from the transport aircraft 12 or ground-based systems. With reference to FIGS. 2 and 3, the UAV includes selectively manipulatable control surfaces in the form of wing 26 and tail 28 surfaces which can be manipulated, similar to manned aircraft, for controlling the direction and flight of the UAV. The UAV may also include a propulsion system, such as a jet or turbine or propellor 30.

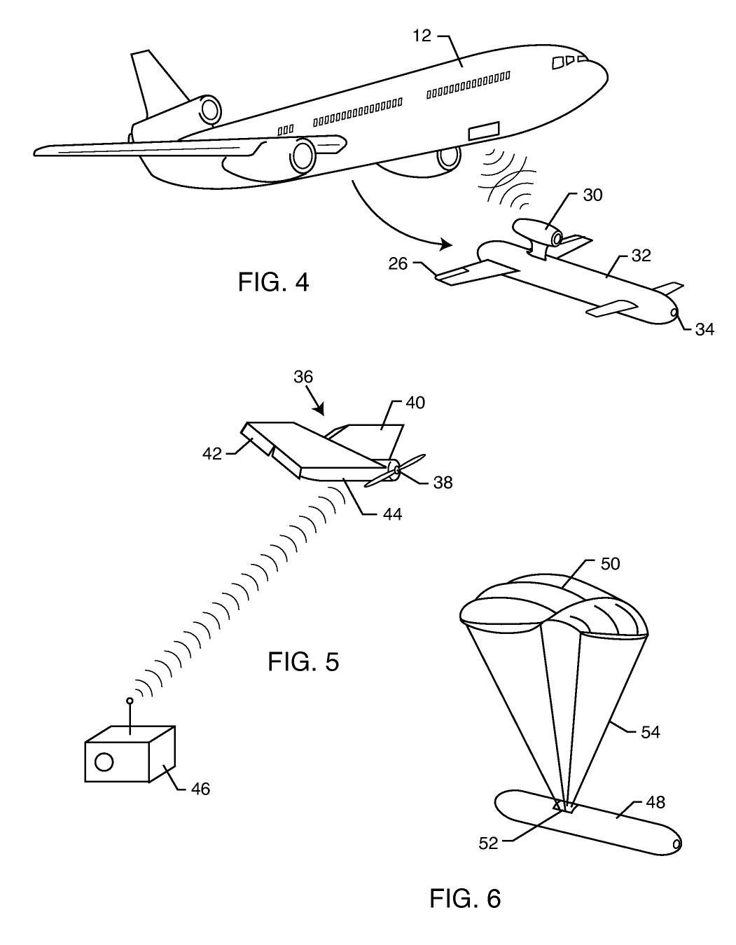

With reference now to FIG. 4, yet another UAV 32 is illustrated having wing control flaps or surfaces 26 and a propulsion system 30, in the form of a jet engine. The UAV may also include any of the sensors mentioned above, optical cameras, infrared imaging systems, or the like 34 which are used to control and guide the flight of the UAV to its intended target.

With reference now to FIG. 5, yet another UAV 36 is illustrated. In this embodiment, the UAV includes a propellor 38 to propel the UAV in a controlled manner. The UAV also includes wings 40 and flaps and control surfaces 42 for controlling the flight of the UAV. A storage tank or the like is formed within the body 44 of the UAV.

It will also be appreciated that the UAV need not have a propulsion system, but instead could be an unpowered gliding vehicle with aerodynamic surfaces for controlling its path to the target, or on-board reaction jets for controlling the UAV path to target. With reference to FIG. 6, in addition to a glider, the UAV 48 may include a deployable parachute structure, in the form of a paraglider parachute 50 which can be used similar to a paraglider by means of actuators or the like 52 within or operably connected to the UAV 48 which control the cords 54 of the paraglider 50 for controllably moving the UAV to its intended target.

As mentioned above, the UAV can be in communication with, and remotely guided and controlled either by the transport aircraft 12, as illustrated in FIG. 4, or by a ground-based system 46, as illustrated in FIGS. 1 and 5. Either the transport aircraft 12 or the ground-based systems 22, 24 or 46 could be used to wirelessly control the speed, altitude, attitude, and maneuvering of the UAV and the eventual release of its fire extinguishing or retardant material. This may be done by visual contact with the UAV, utilizing cameras or other optical equipment or sensors, such as infrared sensors or pattern recognition devices to guide the UAV, or by means of the data collected in the data processor 108, as described above. Typically, the UAV will include transmitters for transmitting its location, speed, etc.

Thus, the UAV includes actuators either controlled by its own internal computer, or by the airborne or land-based control systems which cause maneuvering forces to be applied to the UAV, such as with movable control surfaces, controllable fluid jets, controls to a parachute or parasol device or other suitable means. If the UAV includes a propulsion system, in the form of a propellor or jet or the like, the propulsion system can modify the UAV's altitude or speed during any segment of its flight, as desired by the controller.

The one or more fluid containers can be selectively opened either by the UAV using its own preprogrammed or updated processed information data, or by airborne or ground-based controllers so as to discharge the fire extinguishing or retardant fluid or material onto the fire or fire path. Thus, the UAV will include suitable actuation means for opening the fluid container, including valves, parachutes, electrical actuators, explosive actuators, latches, doors, or other means for dispensing the fire extinguishing or retardant material. This may be done on command remotely from the airborne or land-based control systems, or according to the pre-defined mission plan within the UAV.

Although it is possible that the UAV is a single use device, possibly constructed of frangible material so as to crash into the fire area, in a preferred embodiment the UAV is recoverable. Thus, the UAV includes landing aids that may include parachutes, paraglider lifting devices, airbags, wheels, or the like which enhance the recoverability of the vehicle with minimal or no damage.

Thus, in accordance with the present invention, one or more UAVs 16 are attached to or placed within a transport aircraft 12 and carried to an altitude and location in relation, typically in close proximity, to a fire area. The UAVs include at least one storage container which has either been pre-filled with fire extinguishing or retardant material, or which is filled during flight by means of the transport aircraft 12. The UAV is then launched or ejected away from the transport aircraft, and guided and controlled, either by onboard systems having a pre-defined mission plan, which can be updated as needed, or by means of airborne or ground-based control systems. The UAV is flown into close proximity over the fire or anticipated fire path where it releases its fire extinguishing or retardant material either according to the predefined flight plan, or by means of remote command. It is anticipated to include means to override the UAV's onboard systems and command that the fluid be released prematurely if it is deemed appropriate to abort the attack on the fire, due to failure detected in the UAV during flight or if there is danger in the fire zone to other equipment or personnel. Typically, the UAV then employs landing aids, or is directed to a landing area for recovery and reuse.

It will be appreciated by those skilled in the art that the system of the present invention can be utilized at times of the day and in conditions where it is dangerous, difficult, or even impossible for manned aircraft to perform the same functions. Thus, the UAVs of the present invention can be used during the night, low visibility conditions, or even windy conditions which would prevent helicopters and manned air tankers from fighting fires. Moreover, the present invention eliminates the need for pilots of such aircraft to fly in low and precariously skim the smoldering hills and trees the way that is currently done.

Although several embodiments have been described in detail for purposes of illustration, various modifications may be made without departing from the scope and spirit of the invention. Accordingly, the invention is not to be limited, except as by the appended claims.

What is claimed is:

1. A method for extinguishing fires, comprising:
loading an unmanned aerial vehicle (UAV) onto a transport aircraft;
carrying the UAV to an altitude and location in relation to a fire area using the transport aircraft;
launching the UAV from the transport aircraft;
guiding the UAV over the fire area; and
releasing fire extinguishing or retardant material from the UAV and onto the fire area.

2. The method of claim 1, wherein the fire area comprises a fire or an anticipated fire path.

3. The method of claim 1, wherein the loading step comprises the step of attaching the UAV to the exterior of the transport aircraft.

4. The method of claim 1, wherein the loading step comprises the step of placing the UAV into the transport aircraft.

5. The method of claim 1, wherein the guiding step comprises the step of communicating with and controlling flight of the UAV.

6. The method of claim 5, including the step of using a ground based communicator or the transport aircraft to control the UAV.

7. The method of claim 5, including the step of using UAV fixed or deployable aerodynamic structures for guiding and controlling the flight of the UAV.

8. The method of claim 7, wherein the fixed or deployable aerodynamic structures comprise at least one of a propulsion system, and controllable wing structures operably connected to the UAV.

9. The method of claim 8, wherein the propulsion system comprises a propellor or a jet.

10. The method of claim 5, wherein the guiding step includes the step of using navigation positioning data.

11. The method of claim 10, wherein the navigation positioning data comprises at least one of global positioning satellite (GPS) data, radio beacon data, very high frequency omni-directional range (VOR) data, and long range aid to navigation (LORAN) data.

12. The method of claim 5, wherein the guiding step includes the step of using wireless electromagnetic waves to remotely guide and control the flight of the UAV.

13. The method of claim 5, wherein the guiding step includes the step of using an optical sensor or camera to remotely guide the UAV.

14. The method of claim 1, including the step of importing data into a data processor for controlling the UAV.

15. The method of claim 14, wherein the importing data step includes the step of importing the data into a data processor of the transport vehicle or a ground based control system in communication with the UAV.

16. The method of claim 1, including the step of determining conditions relating to the fire.

17. The method of claim 16, wherein the determining conditions step includes the step of sensing weather conditions, including wind speed and direction.

18. The method of claim 1, including the step of determining conditions relating to the flight of the UAV.

19. The method of claim 18, wherein the determining conditions step includes the monitoring at least one of altitude, speed, and location of the UAV.

20. A method for extinguishing fires, comprising:
loading an unmanned aerial vehicle (UAV) onto a transport aircraft;
carrying the UAV to an altitude and location in relation to a fire area comprising a fire or an anticipated fire path using the transport aircraft;
launching the UAV from the transport aircraft;
guiding the UAV over the fire area using controllable fixed or deployable aerodynamic structures of the UAV;
determining conditions relating to the fire, including weather conditions;
monitoring flight conditions of the UAV, including altitude and location of the UAV; and
releasing fire extinguishing or retardant material from the UAV and onto the fire area.

21. The method of claim 20, wherein the loading step comprises the step of attaching the UAV to the exterior of the transport aircraft or placing the UAV into the transport aircraft.

22. The method of claim 20, wherein the guiding step comprises the step of communicating with and controlling flight of the UAV using a ground based communicator or the transport aircraft to control the UAV.

23. The method of claim 22, wherein the fixed or deployable aerodynamic structures comprise at least one of a propellor, a jet, and controllable wing structures operably connected to the UAV.

24. The method of claim 20, wherein the guiding step includes the step of using navigation positioning data, including at least one of global positioning satellite (GPS) data, radio beacon data, very high frequency omni-directional range (VOR) data, and long range aid to navigation (LORAN) data.

25. The method of claim 20, wherein the guiding step includes the step of using wireless electromagnetic waves or an optical sensor or camera to remotely guide and control the flight of the UAV.

26. The method of claim 20, including the step of importing data into a data processor of the transport vehicle or a ground based control system for controlling the UAV.
